(19) United States
(12) Patent Application Publication
(10) Pub. No.: US 2026/0336676 A1
(43) Pub. Date: Oct. 29, 2026

(54) SHOPPING CART

(71) Applicant: DONGGUAN BAOYU HARDWARE PRODUCTS CO., LTD, Dongguan (CN)

(72) Inventor: Liangwen HUANG, Dongguan (CN)

(73) Assignee: DONGGUAN BAOYU HARDWARE PRODUCTS CO., LTD, Dongguan (CN)

(21) Appl. No.: 19/716,230

(22) Filed: Jun. 23, 2026

Related U.S. Application Data
(63) Continuation of application No. PCT/CN2025/072318, filed on Jan. 14, 2025.

(30) Foreign Application Priority Data
Dec. 26, 2024 (CN) 202423230676.8

(51) Int. Cl. B62B 3/02; B62B 3/00

(52) U.S. Cl. CPC B62B 3/027; B62B 3/002

(57) ABSTRACT

A shopping cart includes: left and right walls, where the left and right walls each include a first panel and a second panel, a first track on the first panel and a second track on the second panel form a locking region, and bending portions on the first and second panels are disposed in the locking region; and a locking panel, where a first matching member and a second matching member are disposed on the locking panel; when the locking panel moves to a first preset position, the first and second matching members are respectively disengaged from corresponding bending portions, such that the first and second panels can rotate relatively; and when the locking panel moves to a second preset position, the first and second matching members are respectively engaged with the corresponding bending portions to prevent the rotation of the first and second panels.

### CROSS REFERENCE TO THE RELATED APPLICATIONS

This application is a continuation application of International Application No. PCT/CN2025/072318, filed on Jan. 14, 2025, which is based upon and claims priority to Chinese Patent Application No. 202423230676.8, filed on Dec. 26, 2024, the entire contents of which are incorporated herein by reference.

### TECHNICAL FIELD

The present disclosure belongs to the field of shopping carts, and specifically relates to a shopping cart.

### BACKGROUND

In the prior art, as common auxiliary tools for consumers in outdoor shopping, shopping carts can help the consumers carry bulky or heavy purchased goods back to their vehicles or residences, and have high utilization rates and wide applicability. To meet increasing user requirements for portability and storage of the shopping carts, foldable shopping carts have been developed. Such carts can be folded before use for convenient carrying and easy storage. Furthermore, they are compact and space-efficient if stored at home.

The foldable shopping cart disclosed in US 11338835 B2 achieves folding and unfolding of the wall by sliding locking buckles on upper edges of two movable panels constituting the wall. However, as the locking buckles are respectively slidably disposed on the edges of the two movable panels, a contact area between each locking buckle and the corresponding movable panel is small, resulting in a limited supporting force. Consequently, the connection strength between the locking buckle and the movable panel is low, the cart is easily damaged, and the sliding process is not smooth, leading to poor user experience.

### SUMMARY

The present disclosure is proposed based on the above requirements in the prior art. A technical problem to be solved by the present disclosure is to provide a shopping cart with improved connection performance.

To solve the above problem, the present disclosure provides the following technical solutions:

A shopping cart includes: front and rear walls that extend along a lateral direction; left and right walls that extend along a longitudinal direction, where the left and right walls are connected to the front and rear walls, two connected walls are rotatably coupled, the left and right walls each include a first panel and a second panel, the first panel is rotatably coupled to the second panel, a first track on the first panel and a second track on the second panel form a locking region, a locking module is disposed in the locking region, and the locking module includes a bending portion on the first panel and a bending portion on the second panel; and a locking panel that moves in the locking region along a vertical direction and covers both the first track and the second track during movement, where a first matching member corresponding to the bending portion on the first panel and a second matching member corresponding to the bending portion on the second panel are disposed on the locking panel; when the locking panel moves to a first preset position in the locking region, the first matching member and the second matching member are respectively disengaged from corresponding bending portions, such that a degree of freedom (DOF) for relative rotation is formed between the first panel and the second panel, and the shopping cart is changed into a folded state based on the rotation; and when the locking panel moves to a second preset position in the locking region, the first matching member and the second matching member are respectively engaged with the corresponding bending portions to prevent the rotation of the first panel and the second panel, such that the shopping cart can be maintained in an unfolded state.

The above arrangement can realize folding and unfolding of the shopping cart. In addition, to unlock and unfold the shopping cart, the locking panel moves correspondingly, and a region slid by the locking panel during movement covers both the first track and the second track, such that a large surface contact is realized between the locking panel and the locking region, thereby ensuring a smooth sliding process, and a relatively high strength in a locked state. Furthermore, as the locking panel is correspondingly connected to the left and right walls, thicknesses of the left and right walls can be designed flexibly.

Preferably, the bending portion on the first panel is disposed in an upper region and/or a lower region of the first track, and the bending portion on the second panel is disposed in an upper region and/or a lower region of the second track.

Preferably, a first groove corresponding to and matching with the bending portion in the upper region of the first track and/or the second track is formed in the locking panel; when the locking panel moves to the first preset position in the locking region, the bending portion in the upper region of the first track and/or the second track is disengaged from the first groove, such that the first panel and the second panel can rotate relative to each other; and when the locking panel moves to the second preset position in the locking region, the bending portion in the upper region of the first track and/or the second track at least partially extends into the first groove, so as to relatively lock and prevent the rotation of the first panel and the second panel.

The above structure realizes the locking and unlocking of the shopping cart.

Preferably, the locking panel includes a second portion corresponding to and matching with the bending portion in the lower region of the first track and/or the second track; when the locking panel moves to the first preset position in the locking region, the second portion is disengaged from the bending portion in the lower region of the first track and/or the second track, such that the first panel and the second panel can rotate relative to each other; and when the locking panel moves to the second preset position in the locking region, the second portion at least partially extends into the bending portion in the lower region of the first track and/or the second track, so as to relatively lock and prevent the rotation of the first panel and the second panel.

The above structure realizes the locking and unlocking of the shopping cart.

Preferably, the locking region includes a first limiting groove and a second limiting groove that are arranged up and down in the first panel; an elastic member is disposed on the locking panel; the elastic member has a DOF of moving in a direction perpendicular to a plane where the locking region is located; the elastic member matches with the first limiting groove and the second limiting groove; the locking panel is configured to drive the elastic member to move between the first limiting groove and the second limiting groove; when the elastic member is embedded into the first limiting groove, the locking panel correspondingly moves to the first preset position; and when the elastic member is embedded into the second limiting groove, the locking panel correspondingly moves to the second preset position.

Through the above arrangement, the locking panel moving to a determined position can remain stationary and stable.

Preferably, the bending portion in the upper region of the first track and/or the second track is a first bending portion; the first bending portion includes a horizontal portion extending along a horizontal direction and a vertical portion extending along the vertical direction; the horizontal portion is connected to the locking region; and when the locking panel is located at the second preset position, the first bending portion and the first groove at least partially overlap with each other.

Preferably, the bending portion in the lower region of the first track and/or the second track is a second bending portion; the second bending portion includes a horizontal portion extending along the horizontal direction and a vertical portion extending along the vertical direction; and the horizontal portion is connected to the locking region, and the vertical portion is parallel to the locking region, thereby forming a space for allowing the locking panel to be inserted.

Preferably, a protrusive bending portion is further disposed on the first panel; the protrusive bending portion includes a vertical portion extending along the vertical direction and a horizontal portion extending along a horizontal direction; the vertical portion is connected to the first panel, and the horizontal portion protrudes from the first panel and is parallel to the first panel; an opening is formed in the locking panel; an embedded bending portion is disposed at the opening; the embedded bending portion is located on a surface of the locking panel away from an interior of the shopping cart; the embedded bending portion matches with the protrusive bending portion; and when the locking panel moves between the first preset position and the second preset position, the protrusive bending portion and the embedded bending portion at least partially overlap with each other.

Through the above arrangement, in an unlocked state, the locking panel can be fixedly connected relative to the first panel to prevent falling.

Preferably, a preset groove is formed in the locking panel; a bottom of the preset groove includes a plurality of portions that are spaced apart; and a wall under a portion of the bottom is missing, so as to provide a DOF of movement, thereby forming the elastic member.

Through the above arrangement, the elastic member and the locking panel are integrally formed to prevent the elastic member from falling, which would otherwise cause positioning failure and affect the use.

Preferably, the first limiting groove and the second limiting groove have different depths at different positions in the vertical direction; for each of the first preset groove and the second preset groove, the depths gradually increase from upper and lower ends to a center; a protrusion is disposed on a surface of the elastic member close to an exterior of the shopping cart; and the protrusion matches with the first limiting groove and the second limiting groove.

The above arrangement facilitates movement of the elastic member, without compromising stability when the locking panel is located at the determined position.

Compared with the prior art, the present disclosure can realize the folding and unfolding of the shopping cart. In addition, to unlock and unfold the shopping cart, the locking panel moves correspondingly, and a region slid by the locking panel during movement covers both the first track and the second track, such that a large surface contact is realized between the locking panel and the locking region, thereby ensuring a smooth sliding process, and a relatively high strength in a locked state. Furthermore, as the locking panel is correspondingly connected to the left and right walls, thicknesses of the left and right walls can be designed flexibly. By providing the bending portions on the first panel and the second panel as well as the groove and the second portion respectively corresponding to the bending portions on the locking panel, the present disclosure realizes the locking and unlocking. In an unlocked state, the shopping cart has a certain DOF and can be folded. In the locked state, the shopping cart has certain connection strength. Further, the first limiting groove and the second limiting groove are formed in the first panel. Meanwhile, the elastic member corresponding to the first limiting groove and the second limiting groove is disposed on the locking panel. When the locking panel moves, the elastic member moves between the first limiting groove and the second limiting groove, and keeps relatively stable in the first limiting groove and the second limiting groove. In addition, through connection between the protrusive bending portion and the embedded bending portion, the locking panel can be fixedly connected relative to the first panel, regardless of the locked state or the unlocked state.

### BRIEF DESCRIPTION OF THE DRAWINGS

To describe the technical solutions in embodiments of the present disclosure or in the prior art more clearly, the following briefly describes the drawings required for describing the embodiments of the present disclosure or in the prior art. Apparently, the drawings in the following description show merely some embodiments of the present disclosure, and those of ordinary skill in the art may still derive other drawings from these drawings.

FIG. 1 is a schematic structural view of a first surface of a locking panel according to an embodiment of the present disclosure;

FIG. 2 is a schematic structural view of a second surface of a locking panel according to an embodiment of the present disclosure;

FIG. 3 is a schematic structural view of connection for a first panel and a second panel according to an embodiment of the present disclosure;

FIG. 4 is a schematic structural view of a locking region according to an embodiment of the present disclosure;

FIG. 5 is a schematic structural view of connection in a locked state of a locking panel according to an embodiment of the present disclosure;

FIG. 6 is a schematic structural view of connection in an unlocked state of a locking panel according to an embodiment of the present disclosure;

FIG. 7 is a schematic structural view of a shopping cart in an unfolded state according to an embodiment of the present disclosure;

FIG. 8 is a schematic structural view of a shopping cart in another unfolded state according to an embodiment of the present disclosure; and

FIG. 9 is a schematic structural view of a shopping cart in a folded state according to an embodiment of the present disclosure.

### REFERENCE NUMERALS

1: first panel,
2: second panel,
3: locking region,
4: locking panel,
5: first portion,
6: second portion,
7: first limiting groove,
8: second limiting groove,
9: elastic member,
   901: protrusion,
10: preset groove,
11: first bending portion,
12: second bending portion,
13: first groove,
   1301: first sub-groove,
   1302: second sub-groove,
14: communication hole,
15: first surface,
16: second surface,
17: protrusive bending portion,
18: embedded bending portion,
19: opening,
20: buckle,
21: universal wheel, and
23: pull rod.

### DETAILED DESCRIPTION OF THE EMBODIMENTS

In order to make the objectives, technical solutions and advantages of the embodiments of the present disclosure more clear, the technical solutions in the embodiments of the present disclosure will be clearly and completely described below in conjunction with the drawings in the embodiments of the present disclosure. Apparently, the described embodiments are some rather than all of the embodiments of the present disclosure. All other embodiments derived by persons of ordinary skill in the art on the basis of the embodiments in the present disclosure without creative efforts should fall within the protection scope of the present disclosure.

In the description of the embodiments of the present disclosure, it should be noted that, unless otherwise clearly specified, the term "connected to" should be understood in a broad sense. For example, a connection may be a fixed connection, a removable connection, an integral connection, a mechanical connection, an electrical connection, a direct connection, or an indirect connection through a medium. A person of ordinary skill in the art may understand specific meanings of the foregoing terms in the present disclosure based on a specific situation.

The terms "top", "bottom", "above...", "lower", and "upper" used in the full text refer to relative positions of components of a device, such as relative positions of top and bottom substrates inside the device. It can be understood that the device is multifunctional, which is independent of an orientation of the device in a space.

For ease of understanding of the embodiments of the present disclosure, some specific embodiments of the present disclosure are described in further detail below in conjunction with the drawings, and these specific embodiments do not constitute a limitation to the embodiments of the present disclosure.

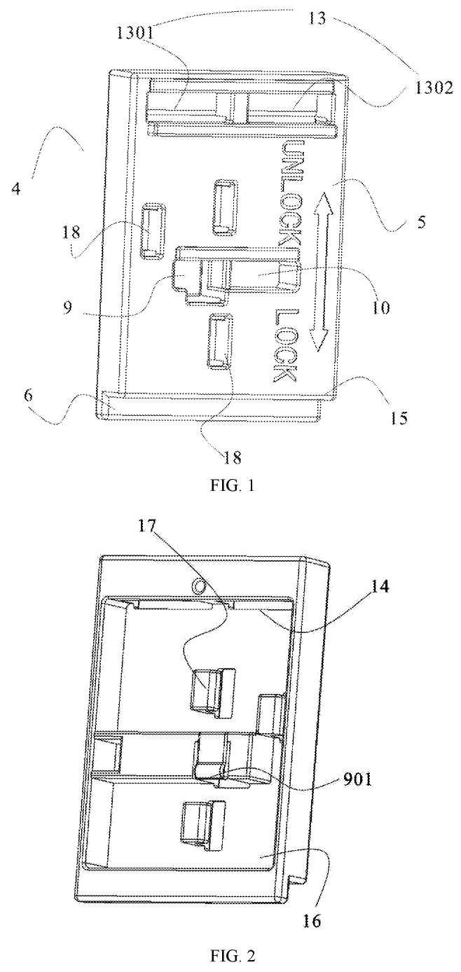

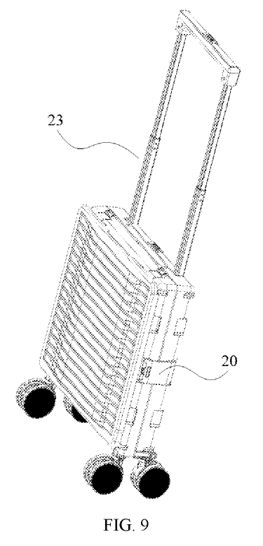

An embodiment provides a shopping cart, as shown in FIGS. 1-9.

As shown in FIG. 8, the shopping cart is in the shape of a cube, and has six walls, i.e., a front wall, a rear wall, a left wall, a right wall, a top wall, and a bottom wall. Pull rod 23 is disposed on the rear wall of the shopping cart, and a length of the pull rod 23 is adjusted as needed. Further, the pull rod 23 is pivoted about an edge of the bottom wall of the shopping cart, and rotates between a first limiting position and a second limiting position, so as to match different pulling states. At the first limiting position, the pull rod 23 abuts against the rear wall. The front wall, the left wall, the rear wall, and the right wall are connected in sequence. Two connected walls are rotatably coupled.

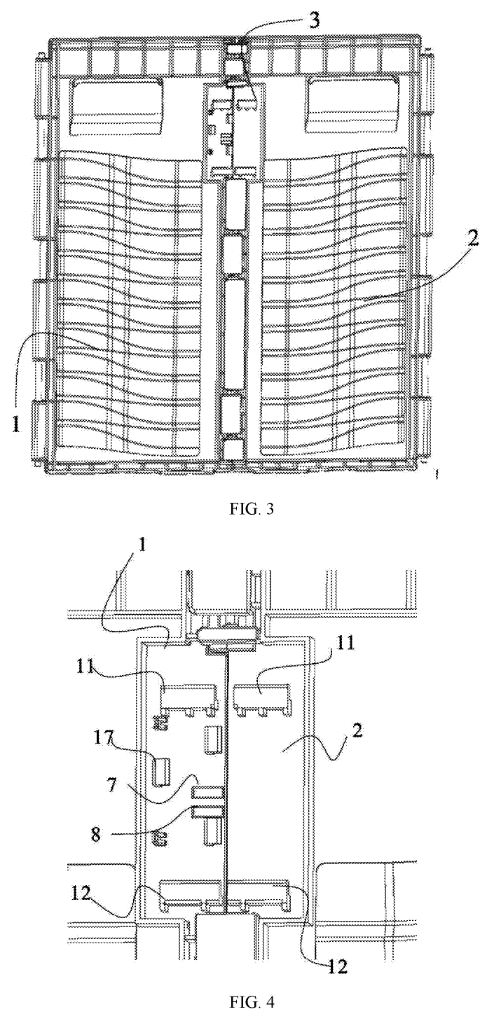

As shown in FIGS. 2-3, the left wall and the right wall each include first panel 1 and second panel 2. The first panel 1 is rotatably coupled to the second panel 2. A connected side of each of the first panel 1 and the second panel 2 is provided with a pivoting connection structure, such that an included angle between the first panel 1 and the second panel 2 changes between 0° and 180°. Meanwhile, limited by locking panel 4, the first panel 1 and the second panel 2 can only be folded toward an interior of the shopping cart when subjected to an external force.

Lengths of the left wall and the right wall are less than lengths of the front wall and the rear wall. When the included angle between the first panel 1 and the second panel 2 changes from 180° to 0°, the first panel 1 rotates relative to the rear wall, the second panel 2 rotates relative to the front wall, and the front wall moves close to the rear wall, until the included angle between the first panel 1 and the second panel 2 is 0°, and both the left wall and the right wall are parallel to the front wall. At this time, the shopping cart is in a folded state with a minimum size.

A first track is disposed on the first panel 1. A second track is disposed on the second panel 2. The first track and the second track form locking region 3. A surrounding wall perpendicular to the first panel 1 and the second panel 2 is disposed around the locking region 3 to enclose the locking region 3. A length of the locking region 3 in a vertical direction is greater than a length of the locking panel 4 in the vertical direction. The locking panel 4 is movable along the vertical direction in the locking region 3, so as to cooperate with a locking module in the locking region 3 to realize locking and unlocking of the shopping cart. The locking panel can cover both the first track and the second track when moving up and down.

As shown in FIGS. 1-2, the locking panel 4 includes first portion 5 and second portion 6 that are connected to each other. The first portion 5 is located in an upper region of the locking panel 4. The second portion 6 is located in a lower region of the locking panel 4. The locking panel 4 has first surface 15 and second surface 16. The first surface 15 is a surface of the locking panel 4 toward the interior of the shopping cart, and the second surface 16 is a surface of the locking panel 4 toward an exterior of the shopping cart.

Specifically, the locking panel 4 moves along the vertical direction in the locking region 3 and can remain stationary at specific positions. That is, it can be stably maintained in a state when moving to a specified position, and stably maintained in another state when moving to another specified position, which is realized by cooperation of the following structures:

The locking module includes first limiting groove 7 and second limiting groove 8 that are formed in the first panel 1, sequentially arranged up and down along the vertical direction, and respectively located at a first position and a second position. The first limiting groove 7 and the second limiting groove 8 have a depth direction away from the interior of the shopping cart, and a length direction being a horizontal direction. The first limiting groove 7 has different depths at different positions in the vertical direction, which gradually decrease from a center to two sides. Preferably, a depth variation of the first limiting groove 7 in the vertical direction is approximately arc-shaped. The second limiting groove 8 is formed in a similar way as the first limiting groove 7.

Correspondingly, elastic member 9 cooperating with the first limiting groove 7 and the second limiting groove 8 is disposed on the locking panel 4. The elastic member 9 has an elastic DOF close to or away from the interior of the shopping cart. A surface of the elastic member 9 close to the exterior of the shopping cart is provided with protrusion 901. The protrusion 901 matches with the first limiting groove 7 and the second limiting groove 8. When the locking panel 4 is pushed by an external force to move in the vertical direction, the elastic member 9 is driven to move accordingly. The elastic member 9 is engaged in the first limiting groove 7 and the second limiting groove 8, thereby limiting a moving position of the locking panel 4. When the protrusion 901 is embedded into the first limiting groove 7, both are fixed relatively, the locking panel 4 is in an unlocked state, and the first panel 1 and the second panel 2 can rotate relatively. In this case, by changing the included angle between the first panel 1 and the second panel 2, the state of the shopping cart can be changed. For example, the shopping cart in an unfolded state is folded. When the locking panel 4 moves until the protrusion 901 is embedded into the second limiting groove 8, both can remain relatively fixed without manual intervention. At this time, the locking panel is in a locked state, the first panel 1 and the second panel 2 are fixed relatively, and the state of the shopping cart is unchangeable.

Further, the elastic member 9 is disposed on the first portion 5. Preset groove 10 is formed in the first portion 5. The preset groove 10 has a depth extending away from the interior of the shopping cart, and a length extending along the horizontal direction. A bottom of the preset groove 10 is divided into a plurality of portions that are spaced apart. A wall under a portion of the bottom is missing, and this portion has a DOF of movement, i.e., is provided with the elastic member 9.

The locking of the first panel 1 and the second panel 2 through the locking panel 4 and the unlocking of the first panel 1 and the second panel 2 through the locking panel 4 are realized by the following structure:

The locking module further includes first bending portion 11 and second bending portion 12 that are disposed on both the first panel 1 and the second panel 2. The first bending portion 11 is located in an upper portion of the locking region 3. The second bending portion 12 is located in a lower portion of the locking region 3. Each of the first bending portion 11 and the second bending portion 12 includes a horizontal portion extending in the horizontal direction and a vertical portion extending in the vertical direction. The horizontal portion is connected to the vertical portion to form a bend. The horizontal portion of the first bending portion 11 is connected to each of a corresponding surface of the first panel 1 and a corresponding surface of the second panel 2. The horizontal portion of the second bending portion 12 is connected to each of a corresponding surface of the first panel 1 and a corresponding surface of the second panel 2.

When the first panel 1 and the second panel 2 are located on a same plane, i.e., the included angle between the first panel 1 and the second panel 2 is 180°, the first bending portion 11 on the first panel 1 and the first bending portion 11 on the second panel 2 are located on a same horizontal line, and the second bending portion 12 on the first panel 1 and the second bending portion 12 on the second panel 2 are located on a same horizontal line,

First groove 13 that is located in an upper portion of a side of the first portion 5 away from the interior of the shopping cart is formed in the locking panel 4. A depth direction of the first groove 13 extends toward the exterior of the shopping cart, such that a bottom of the first groove 13 is closer to the exterior than a notch of the first groove 13. A side of the first groove 13 is disposed around the bottom. A lower region of the first groove 13 is provided with a structure through which the first groove 13 can communicate with the second surface 16 toward the exterior of the shopping cart, including but not limited to a through hole. In a feasible implementation of this embodiment, the first groove 13 is not provided with a lower wall, so as to directly communicate with another side of the locking panel 4, i.e., the second surface 16. For ease of subsequent description, the structure for communicating the first groove 13 with the second surface 16 is referred to as communication hole 14.

Further, the first groove 13 includes first sub-groove 1301 and second sub-groove 1302. The first sub-groove 1301 is separated from the second sub-groove 1302 through a baffle. The first sub-groove 1301 corresponds to the first bending portion 11 on the first panel 1, and the second sub-groove 1302 corresponds to the first bending portion 11 on the second panel 2.

The first bending portion 11 structurally matches with the first groove 13. In the locked state, the vertical portion of the first bending portion 11 extends into the first groove 13 through the communication hole 14 from bottom to top, and the horizontal portion of the first bending portion 11 abuts against the bottom of the first groove 13. Further, the first bending portion 11 on the first panel 1 is engaged with the first sub-groove 1301, and the first bending portion 11 on the second panel 2 is engaged with the second sub-groove 1302.

A thickness of the first portion 5 of the locking panel 4 is greater than a thickness of the second portion 6, such that a boss is formed on the first surface 15 of the locking panel 4. The second portion 6 matches the second bending portion 12. In the locked state, the second portion 6 is embedded into the second bending portion 12, and specifically embedded into a space formed by the horizontal portion and the vertical portion of the second bending portion 12.

Through cooperation between the first groove 13 and the first bending portion 11 as well as cooperation between the second portion 6 and the second bending portion 12, the first panel 1 and the second panel 2 are fixed on a same plane, and the relative rotation of the first panel 1 and the second panel 2 is restricted, thereby achieving the locking.

As shown in FIG. 5, when a plane where the first panel 1 is located overlaps with a plane where the second panel 2 is located, i.e., the included angle formed between the first panel 1 and the second panel 2 is 180°, if the elastic member 9 is embedded into the second limiting groove 8 by pushing the locking panel 4, the first bending portion 11 has the horizontal portion abutting against the bottom of the first groove 13, and the vertical portion extending into the first groove 13. The second portion 6 is embedded into the space formed by the horizontal portion and the vertical portion of the second bending portion 12, such that two ends of the locking panel 4 in the vertical direction are respectively fixed on the first panel 1 and the second panel 2, thereby realizing the locking. In this case, the first panel 1 and the second panel 2 cannot rotate relatively.

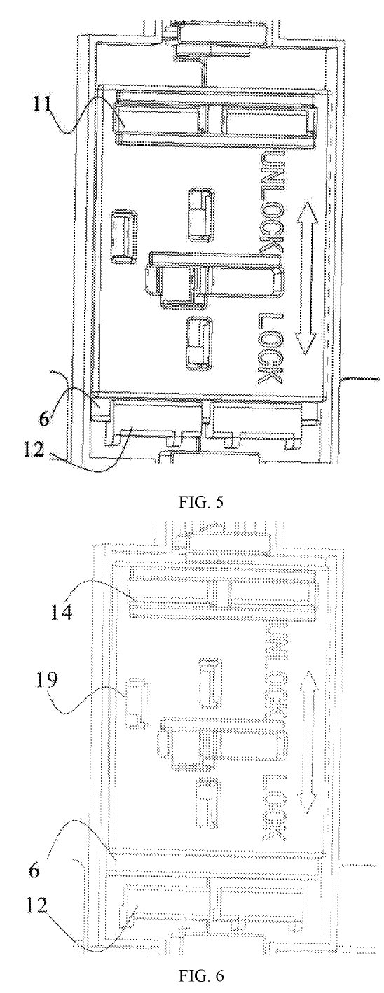

As shown in FIG. 6, when the shopping cart is unlocked, the locking panel 4 is pushed, such that the elastic member 9 is embedded into the first limiting groove 7. At this time, the first bending portion 11 is not connected to the first groove 13, the second bending portion 12 is not connected to the second portion 6, and the first panel 1 and the second panel 2 can rotate relatively. That is, in the unlocked state, the shopping cart can be folded into a plate-like structure to reduce the occupied space, facilitating carrying and placement.

After the shopping cart is unlocked and folded, the first panel 1 can still be fixedly connected relative to the locking panel 4, which is realized by the following structure:

The locking module further includes a plurality of protrusive bending portions 17 that are disposed on a side of the first panel 1 close to the interior of the shopping cart. The plurality of protrusive bending portions 17 each include a vertical portion perpendicular to the surface of the first panel 1 and a horizontal portion parallel to the surface of the first panel 1. The vertical portion is connected to the horizontal portion. The vertical portion is connected to the surface of the first panel 1. The horizontal portion protrudes from an inner side of the first panel 1.

In a feasible implementation of this embodiment, three protrusive bending portions 17 are disposed on the first panel 1. Two protrusive bending portions 17 are spaced apart up and down. The upper protrusive bending portion 17 is disposed between the first bending portion 11 and the first limiting groove 7, and the lower protrusive bending portion is disposed between the second bending portion 12 and the second limiting groove 8. An edge of the horizontal portion of each of the above two protrusive bending portions 17 coincides with an edge of the first panel 1. The other bending portion includes a horizontal position away from the edge of the first panel 1, and a vertical position located between the two protrusive bending portions 17.

Correspondingly, a plurality of openings 19 are formed in the locking panel 4. Embedded bending portion 18 is disposed at each of the plurality of openings 19. The embedded bending portion 18 includes a vertical portion perpendicular to the locking panel 4 and a horizontal portion parallel to the locking panel 4. The vertical portion is connected to the horizontal portion. The vertical portion is connected to an edge of one side of the opening 19. The horizontal portion is embedded into the side of the locking panel 4 away from the interior of the shopping cart.

The protrusive bending portion 17 corresponds to the embedded bending portion 18. Specifically, the protrusive bending portion 17 is partially misaligned with the embedded bending portion 18, such that the protrusive bending portion 17 at least partially abuts against the embedded bending portion 18 regardless of the locked state or the unlocked state of the shopping cart. That is, in the locked state of the shopping cart, at least a portion of the horizontal portion of the protrusive bending portion 17 abuts against the vertical portion of the embedded bending portion 18. In the unlocked state of the shopping cart, at least a portion of the horizontal portion of the protrusive bending portion 17 abuts against the vertical portion of the embedded bending portion 18.

In a feasible implementation of this embodiment, three embedded bending portions 18 are disposed on the locking panel 4. The three embedded bending portions 18 each correspond to the protrusive bending portion 17 on the first panel 1. That is, the vertical portion of the protrusive bending portion 17 at least partially overlaps with the vertical portion of the embedded bending portion 18.

In the unlocked state of the shopping cart, since the first bending portion 11 on the second panel 2 is disengaged from the first sub-groove 1301 in the locking panel 4, the second bending portion 12 on the second panel 2 is disengaged from the second portion 6 on the locking panel 4, and the second panel 2 can rotate relative to the first panel 1. In addition, since the embedded bending portion 18 on the locking panel 4 is engaged with the protrusive bending portion 17 on the first panel 1, the locking panel 4 is always connected to the first panel 1.

The shopping cart further includes buckle 20. The buckle 20 is disposed on a wall of the shopping cart. Exemplarily, one side of the buckle 20 is disposed on an edge of the rear wall, and rotatably coupled to the rear wall. In the folded state of the shopping cart, another side of the buckle 20 is engaged to an edge of the front wall, such that the shopping cart can be maintained in the folded state. Correspondingly, when the shopping cart changes from the folded state to the unfolded state, the buckle 20 is disengaged from the front wall, allowing the left and right walls of the shopping cart to unfold and providing a DOF for unfolding the shopping cart.

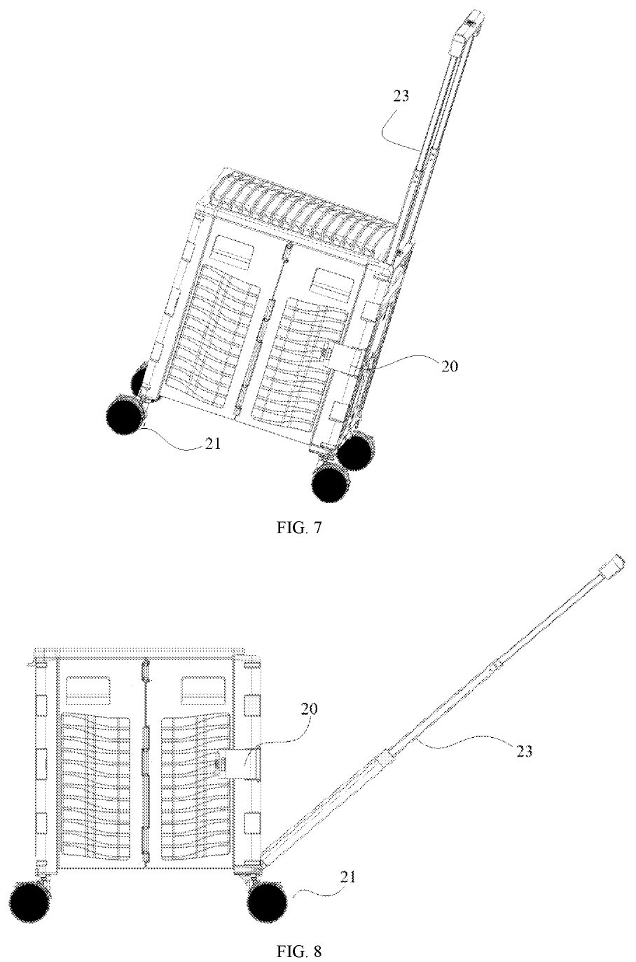

As shown in FIGS. 7-9, the bottom of the shopping cart further includes moving wheels. The moving wheels may be universal wheels 21, or a combination of triangular wheels and universal wheels 21. When the moving wheels are the universal wheels 21, the moving wheels are respectively disposed at four corners of the bottom. When the moving wheels are the combination of triangular wheels and universal wheels 21, the universal wheels 21 are disposed on a front side of the bottom, and the triangular wheels are disposed on a rear side of the bottom.

The objectives, the technical solutions and the beneficial effects of the present disclosure have been further described in detail by means of the above specific implementations, and it should be understood that the above are only the specific implementations of the present disclosure and are not intended to define the scope of protection of the present disclosure. Any modifications, equivalent substitutions, improvements, and the like made within the spirit and principles of the present disclosure should fall within the scope of protection of the present disclosure.

What is claimed is:

1. A shopping cart, comprising:
front and rear walls that extend along a lateral direction;
left and right walls that extend along a longitudinal direction, wherein the left and right walls are connected to the front and rear walls, and two connected walls are rotatably coupled; and
the left and right walls each comprise a first panel and a second panel, the first panel is rotatably coupled to the second panel, a first track on the first panel and a second track on the second panel form a locking region, a locking module is disposed in the locking region, and the locking module comprises a bending portion on the first panel and a bending portion on the second panel; and
a locking panel that moves in the locking region along a vertical direction and covers both the first track and the second track during movement, wherein a first matching member corresponding to the bending portion on the first panel and a second matching member corresponding to the bending portion on the second panel are disposed on the locking panel; when the locking panel moves to a first preset position in the locking region, the first matching member and the second matching member are respectively disengaged from corresponding bending portions, such that a degree of freedom (DOF) for relative rotation is formed between the first panel and the second panel, and the shopping cart is changed into a folded state based on the rotation; and when the locking panel moves to a second preset position in the locking region, the first matching member and the second matching member are respectively engaged with the corresponding bending portions to prevent the rotation of the first panel and the second panel, such that the shopping cart is maintained in an unfolded state.

2. The shopping cart according to claim 1, wherein
the bending portion on the first panel is disposed in an upper region and/or a lower region of the first track, and the bending portion on the second panel is disposed in an upper region and/or a lower region of the second track.

3. The shopping cart according to claim 2, wherein
a first groove corresponding to and matching with the bending portion in the upper region of the first track and/or the second track is formed in the locking panel; and
when the locking panel moves to the first preset position in the locking region, the bending portion in the upper region of the first track and/or the second track is disengaged from the first groove, such that the first panel and the second panel rotate relative to each other; and when the locking panel moves to the second preset position in the locking region, the bending portion in the upper region of the first track and/or the second track at least partially extends into the first groove, so as to relatively lock and prevent the rotation of the first panel and the second panel.

4. The shopping cart according to claim 2, wherein
the locking panel comprises a second portion corresponding to and matching with the bending portion in the lower region of the first track and/or the second track; and
when the locking panel moves to the first preset position in the locking region, the second portion is disengaged from the bending portion in the lower region of the first track and/or the second track, such that the first panel and the second panel rotate relative to each other; and when the locking panel moves to the second preset position in the locking region, the second portion at least partially extends into the bending portion in the lower region of the first track and/or the second track, so as to relatively lock and prevent the rotation of the first panel and the second panel.

5. The shopping cart according to claim 1, wherein
the locking region comprises a first limiting groove and a second limiting groove that are arranged up and down in the first panel; and
an elastic member is disposed on the locking panel; the elastic member has a DOF of moving in a direction perpendicular to a plane where the locking region is located; the elastic member matches with the first limiting groove and the second limiting groove; the locking panel is configured to drive the elastic member to move between the first limiting groove and the second limiting groove; when the elastic member is embedded into the first limiting groove, the locking panel correspondingly moves to the first preset position; and when the elastic member is embedded into the second limiting groove, the locking panel correspondingly moves to the second preset position.

6. The shopping cart according to claim 5, wherein
the bending portion in an upper region of the first track and/or the second track is a first bending portion; the first bending portion comprises a horizontal portion extending along a horizontal direction and a vertical portion extending along the vertical direction; the horizontal portion is connected to the locking region; and when the locking panel is located at the second preset position, the first bending portion and a first groove at least partially overlap with each other.

7. The shopping cart according to claim 6, wherein
the bending portion in a lower region of the first track and/or the second track is a second bending portion; the second bending portion comprises a horizontal portion extending along the horizontal direction and a vertical portion extending along the vertical direction; and the horizontal portion is connected to the locking region, and the vertical portion is parallel to the locking region, thereby forming a space for allowing the locking panel to be inserted.

8. The shopping cart according to claim 1, wherein a protrusive bending portion is further disposed on the first panel; the protrusive bending portion comprises a vertical portion extending along the vertical direction and a horizontal portion extending along a horizontal direction; and the vertical portion is connected to the first panel, and the horizontal portion protrudes from the first panel and is parallel to the first panel;
an opening is formed in the locking panel; an embedded bending portion is disposed at the opening; the embedded bending portion is located on a surface of the locking panel away from an interior of the shopping cart; and the embedded bending portion matches with the protrusive bending portion; and
when the locking panel moves between the first preset position and the second preset position, the protrusive bending portion and the embedded bending portion at least partially overlap with each other.

9. The shopping cart according to claim 1, wherein a preset groove is formed in the locking panel; a bottom of the preset groove comprises a plurality of portions that are spaced apart; and a wall under a portion of the bottom is missing, so as to provide a DOF of movement, thereby forming an elastic member.

10. The shopping cart according to claim 5, wherein a first preset groove and a second preset groove have different depths at different positions in the vertical direction, for each of the first preset groove and the second preset groove, depths gradually increase from upper and lower ends to a center; a protrusion is disposed on a surface of the elastic member adjacent to an exterior of the shopping cart; and the protrusion matches with the first limiting groove and the second limiting groove.
